(19) United States
(12) Patent Application Publication
(10) Pub. No.: US 2026/0103616 A1
(43) Pub. Date: Apr. 16, 2026

(54) COATING COMPOSITION

(71) Applicant: FUTAMURA CHEMICAL UK LTD, Wigton, Cumbria (GB)

(72) Inventors: Martin COCKROFT, Wigton, Cumbria (GB); Luke FISHER, Wigton, Cumbria (GB); Elizabeth KEATING, Wigton, Cumbria (GB)

(21) Appl. No.: 19/113,694

(22) PCT Filed: Oct. 13, 2023
(86) PCT No.: PCT/EP2023/078570

§ 371 Date: Mar. 20, 2025

(30) Foreign Application Priority Data
Oct. 14, 2022 (GB) 2215221.9

(51) Int. Cl. C09D 101/02; C08B 1/00; C08B 16/00

(52) U.S. Cl. CPC C09D 101/02; C08B 1/003; C08B 16/00

(57) ABSTRACT

The present invention provides a coating composition comprising a homogenised dispersion of regenerated cellulose in water, wherein the regenerated cellulose comprises both amorphous and crystalline cellulose.

This application is a National Stage application which claims priority from the international application PCT/EP2023/078570, filed Oct. 13, 2023, which claims priority from GB application No. 2215221.9, filed Oct. 14, 2022. The entirety of aforementioned application is incorporated herein by reference.

### FIELD

The present invention concerns a cellulose coating composition and methods of manufacturing said composition.

### BACKGROUND

Cellulose-based coating compositions are known in the art and are used as barrier coatings, or to increase the hydrophobicity or scratch resistance of an article. The coatings are compostable and biodegradable and so can be used to create eco-friendly articles.

The formation of a cellulose-based coating generally involves applying a cellulose dispersion onto a surface and subsequently drying the dispersion to create a coating layer. Conventionally, the cellulose in the dispersion is microcrystalline cellulose. For example CA668443A discloses boiling a cellulose material in hydrochloric acid in order to create crystalline cellulose, which is then washed and dispersed in water to form a coating composition. Similarly, U.S. Pat. No. 6,541,627 discloses the use of acid hydrolysis to increase the crystallinity of a cellulose-based coating composition.

Crystalline cellulose was considered important for optical properties such as transparency. Thus, the methods of creating cellulose coating materials often involve steps such as acid hydrolysis in order to remove the amorphous cellulose, leaving only the crystalline cellulose in the coating. However, this step can be expensive and complicated, as well as being wasteful as it removes a portion of the cellulose.

Cellulose-based coatings in the art also often include non-biodegradable components or use cellulose derivatives such as nitrocellulose, thereby reducing the biodegradability of the coating itself and increasing the complexity of the manufacturing process.

Dusting is also a problem with the coatings in the art, and so a coating with improved adhesion is also desirable.

It is therefore desirable to create a cellulose-based coating composition that is simpler and cheaper to manufacture, while still maintaining the necessary optical properties and adhesion, as well as being biodegradable.

### BRIEF DESCRIPTION OF THE DRAWINGS

FIG. 1 illustrates an X-ray diffraction (XRD) image of a coating material according to the present invention that has been dried at over 100° C.; and

FIG. 2 illustrates an XRD image of an only slightly dried coating composition according to the present invention.

### DETAILED DESCRIPTION

According to a first aspect of the present invention, there is provided a coating composition comprising a homogenised dispersion of regenerated cellulose in water, wherein the regenerated cellulose comprises both amorphous and crystalline cellulose.

The regenerated cellulose in the coating composition may be predominantly amorphous cellulose. Thus, the regenerated cellulose may be more than 50% amorphous cellulose, preferably more than 75% amorphous cellulose and even more preferably more than 90% amorphous cellulose.

It has surprisingly been found that said homogenised dispersion of regenerated cellulose in water demonstrates good optical properties, such as transparency, without having to remove the amorphous cellulose regions, as is done in the coatings of the prior art. Additionally, the coating of the present invention has good adhesion to a surface and is entirely biodegradable. The present invention therefore provides a simpler and cheaper cellulose coating with good optical properties and adhesion.

Thus, the coating composition of the present invention has not undergone an acid hydrolysis treatment.

The regenerated cellulose may be regenerated from an aqueous alkali cellulose solution. This regeneration method is well known in the art, and involves combining the aqueous alkali cellulose solution with an acid in order to regenerate the cellulose. The use of a cellulose material that has been regenerated from an aqueous alkali cellulose solution is thought to help increase the transparency of the coating, even with amorphous regions, so no acid hydrolysis step is required.

The aqueous alkali cellulose solution may be created by dissolving a cellulose-containing material in an alkali. There are various methods known in the art for creating an aqueous alkali cellulose solution, all of which can be used in the present invention.

The alkali may be a hydroxide, preferably an alkali metal hydroxide and more preferably sodium hydroxide. The alkali may have a concentration between 5% w/w and 25% w/w, or between 10% w/w and 25% w/w. The concentration of alkali in the aqueous alkali cellulose solution may be between 2% w/w and 15% w/w.

The dissolution of cellulose in the alkali may comprise homogenisation to aid dissolution, preferably high-pressure homogenisation. High-pressure homogenisation is used herein to refer to homogenisation that occurs at a pressure of 100 bar or more. More than one homogenisation step may be used during dissolution of the cellulose in the alkali.

The high pressure homogenisation may occur at temperatures of 0° C. or more, to ensure dissolution.

Thus, the dispersion of regenerated cellulose has preferably undergone homogenisation at least twice, firstly to aid dissolution of the cellulose in an alkali and secondly after the regenerated cellulose has been dispersed in water. This is thought to reduce the particle size sufficiently to improve optical properties. There may be more than one homogenisation step at each point of the process. There may be two or more homogenisation steps to aid dissolution of the cellulose in an alkali, and one or two homogenisation steps after the cellulose has been regenerated.

Alternatively, the cellulose may be dissolved in the alkali using any other known method. Alternatively, the cellulose may be dissolved in any other known cellulose solvent, such as ionic liquids, NMMO and deep eutectic solvents.

The cellulose particles preferably have an average radius of less than 1 micron, more preferably less than 0.75 microns. The largest particles may have a radius of less than 2 microns, preferably less than 1.5 microns.

The aqueous alkali cellulose solution may be regenerated in a liquid phase. This can be achieved by conducting the regeneration process under agitation, such as stirring. The regeneration process can involve combining the aqueous alkali cellulose solution with an excess of acid. The aqueous alkali cellulose solution may be added to the acid, or the acid may be added to the aqueous alkali cellulose solution.

It is well-known to dissolve cellulose in an alkali to allow further processing, such as the creation of regenerated cellulose products in the form of a film, a fibre or a shaped article. Regeneration of alkali cellulose solutions is also well known in the art, for example by extruding the solution into an acid. However, this creates a cellulose film with a minimum possible thickness, which is too high to be used as a coating in many applications. In contrast, use of liquid phase regeneration, in which the cellulose is regenerated under agitation, creates a dispersion of regenerated cellulose particles. This dispersion can then be used to create a coating, which is much thinner than the regenerated cellulose films known in the art.

Once the cellulose has been regenerated, it may be washed to achieve a cellulose dispersion in water. The cellulose dispersion in water may be substantially free of the salts created by the acid.

The washing may comprise separating the regenerated cellulose from the acid, washing the regenerated cellulose with water and resuspending the regenerated cellulose in water to form a dispersion. The separation can be done by any conventional means, including filtering, centrifuging or using a vacuum. Alternatively, the washing may comprise continuous washing to remove the acid and create a dispersion of regenerated cellulose in water.

The cellulose dispersion in water may then be homogenised, preferably high-pressure homogenised. The present inventors have found that homogenisation of a dispersion of regenerated cellulose creates sufficiently small cellulose particles that the resulting coating composition has good optical properties, without requiring further processing steps such as acid hydrolysis.

Thus, the homogenised dispersion of regenerated cellulose in water may be obtained using a method comprising the steps of:
(a) dissolving a cellulose-containing material in an aqueous alkali to form an aqueous alkali cellulose solution;
(b) regenerating the cellulose in a liquid phase by combining the aqueous alkali cellulose solution with an excess of acid under agitation;
(c) washing the resulting regenerated cellulose to achieve a cellulose dispersion in water that is substantially free of the salts created by the acid; and
(d) homogenising the cellulose dispersion in water.

These steps, when combined, may have any of the features discussed above.

The cellulose dispersion in water may comprise between 1 and 10% w/w cellulose, preferably between 2 and 7% w/w cellulose.

The cellulose-containing material that is dissolved in an alkali to create the aqueous alkali cellulose solution may be at least partly purified so as to remove some non-cellulose components compared to the starting material. The at least partly purified cellulose-containing material may be produced using the steps of:
neutralising an alkaline cellulose-containing precursor material with an acid and obtaining a neutralised solid cellulose-containing material;
mixing the neutralised solid cellulose-containing material with bleach to create a mixture; and
separating a solid cellulose-containing product from the mixture.

The method above may further comprise step (d) of dissolving the solid purified cellulose-containing product in an aqueous alkali to create an aqueous alkali cellulose solution. One or more steps of this method may be carried out at a temperature between about 2 and about 90° C. and preferably between about 20 and about 60° C.

The acid may comprise a weak acid, which may be a carboxylic acid, such as acetic acid. The concentration of acid may be about 1 to about 20% w/w. The polysaccharide-containing material may be left in the acid for between about 10 minutes and about 3 hours, preferably between about 0.5 and about 1 hours. This can ensure that all of the solid material has been neutralised. The resulting pH of the neutralised solid polysaccharide-containing material may be between 6 and 8, preferably around 7.

The bleach may comprise a chlorine-containing bleach. For example, the bleach may comprise sodium hypochlorite. The bleach may comprise non-chlorine-containing bleach. For example, the bleach may comprise hydrogen peroxide. The bleach may be at a concentration of between 0.1 and 10% w/w, preferably between 0.1 and 2% w/w.

One or more washing steps, using hot and/or cold water, may also be included. The solid cellulose-containing product may be separated from the mixture by any conventional means, including filtration, a vacuum or a centrifuge.

The alkaline cellulose-containing precursor material may be created by combining a cellulose-containing precursor material with an alkali solution to produce an alkali mixture. The alkali mixture may be stirred. The solid alkaline cellulose-containing precursor material may then be separated from the alkali mixture and used in the steps above. The alkali solution may comprise a hydroxide. The alkali solution may be sodium hydroxide. The hydroxide may be present in a concentration of about 0.1 to about 30% w/w by weight of the alkali solution.

These pre-treatment steps have been found to improve the dissolution of the cellulose-containing material in the alkali, to create a stable aqueous alkali cellulose solution that can then be used to create a dispersion of regenerated cellulose, as discussed above.

The coating composition may further comprise one or more additives selected from a wax, a bio-polymer, a pigment, an active ingredient, a reference particle or a dopant for stain uptake. The total amount of additives in the coating composition is preferably less than 40% by weight, with each additive being present at preferably less than 20% by weight.

The wax is preferably bio-based waxes such as carnauba and/or candelilla wax. The wax is preferably biodegradable. The wax can be included in the coating composition to improve hydrophobicity, gloss and scratch resistance.

Bio-polymers are natural polymers that are biodegradable. These include, for example, PHA and bioplastics. Bio-polymers can be added to the coating composition to modify the properties of the resulting coating, depending on the properties of the biopolymer itself. For example, a biopolymer could be added to create sealability.

Pigments or other colourants can be added to the coating composition to modify the colour of the resulting coating.

Active ingredients are components that exhibit a chemical or biological effect on the surrounding environment. For example, the active ingredient may be a zeolite, which can absorb ethylene from the environment. Alternatively, the active ingredient may be an antimicrobial component, such as a component with antibacterial or antiviral activity. These components can therefore be used to provide the resulting coating with a chemical or biological effect on the surrounding environment.

The coating composition may also comprise one or more reference particles. These may be inert particles, and are used as a reference point, often a visual reference point for size or staining comparisons. Reference particles can include PMMA or silica particles, cellulose fibres air bubbles and/or proteins. Reference particles may be of a known size, orientation and/or concentration within the cellulose film. Reference particles can also be randomly distributed to generate a unique pattern, which can be used to identify and/or trace a coated article.

The coating composition of the present invention can also be stained, for example using conventional histology stains including haematoxylin and eosin (H&E), or diaminobenzidine (DAB) and horseradish peroxide (hrp). Thus, the coating composition may include dopants that affect the staining characteristics of the coating composition, such as chitosan, gelatin and/or keratin.

For example, the variability of staining decreases with increasing chitosan levels in the coating. The coating composition may comprise chitosan at 1 to 10%, preferably 3 to 10% and most preferably 5 to 10%. Further, both keratin and gelatin have be found to increase stain uptake. The dopants can be added in an amount such that the stain uptake of the coating matches the stain uptake of the tissue sample of interest. Thus, the coating can be tailored to the tissue sample of interest.

If the coating composition of the present invention is to be used in an application related to histology staining, it may contain both reference particles and dopants. Reference particles can also be used to visually represent the tissue itself, to aid the pathologist in reviewing the sample.

According to a second aspect of the present invention, there is provided a coating comprising the cellulose coating composition discussed above. The coating may be formed by applying the coating composition or a composition containing the coating composition to a surface and then drying the coating. This can be done by any conventional means, for example by gravure, spray or print coating.

The coating may have a thickness of between 0.1 and 50 microns, preferably between 0.5 and 8 microns. Thus, the coating can be significantly thinner than the films created from regenerated cellulose that are known in the art.

The coating may have a coat weight of between 0.1 and 20 gsm, preferably between 1 and 10 gsm. This therefore creates a thin coating on a surface, particularly compared to cellulose films that are known in the art.

The coating may have a wide angle haze of less than 75%, preferably less than 70%. Thus, the coating formed from the coating composition of the present invention has good optical properties.

The coating may have a water vapour permeability of between 1000 and 1250 g/m2/24 hours, preferably between 1050 and 1200 g/m2/24 hours. The water vapour permeability can be altered beyond these ranges by including additives in the coating, in a conventional manner.

The coating may have a good adhesion when dried at above room temperature, with less than 10%, preferably less than 5% of the coating by area being removed in a tape test and little or no visible coating being removed on a scratch test. The tape test involves adhering scotch tape 600 to the coating such that the ends of the tape extend beyond the coating. One end of the tape is held at a 180° angle and removed quickly and that area of coating removal is calculated.

The coating may comprise more than 60% w/w of the cellulose coating composition, preferably more than 80% w/w. The additives mentioned above may make up the rest of the coating. In this embodiment, the cellulose coating composition is used, optionally with some further additives, to create the coating.

Alternatively, the coating may comprise less than 50% w/w of the cellulose coating composition discussed above, preferably less than 20% w/w. The coating may further comprise additional coating compositions, optionally with further additives. In this embodiment, the cellulose coating composition is used as an additive within another coating composition. This can be used to impart advantageous properties, such as print receptivity or adhesion, to a known coating composition using the cellulose coating composition described above.

The coating may have been dried at room temperature (above 20° C.), or around room temperature, for example between 15 and 25° C. It has been found that drying the coating composition at room temperature creates a coating containing a higher amount of amorphous cellulose. This coating is softer and swells on contact with water.

Alternatively, the coating may have been dried at above room temperature (for example, above 25° C.), preferably above 35° C. and more preferably above 50° C. or at 60° C. or above.

It has surprisingly been found that drying the coating composition at temperatures above room temperature creates a hard coating with a good adhesion to a substrate. Without wishing to be bound by theory, it is thought that the heat of the drying process effectively crosslinks the cellulose particles via the hydroxy functionality, creating crystalline structures. Thus, the particles can form hydrogen bonds both to other cellulose particles and to the substrate, thereby creating a hard coating with good adhesion to a substrate, particularly to a glass substrate.

The coating, having been dried at an elevated temperature, may have a crystallinity of above 60%, preferably above 75%. This is much greater than the usual amount of crystallinity seen in conventional cellulose coatings, which can be around 30%. This is also much greater than the amount of crystallinity seen in a coating that has been dried at or around room temperature, which is predominantly amorphous.

The regenerated cellulose may be mostly cellulose II. The regenerated cellulose may be more than 75% cellulose II, preferably more than 85% cellulose II.

According to a third aspect of the present invention, there is provided a coated article, comprising the coating discussed above. The coating provides a thin, biodegradable coating on the article, with good adhesion and optical properties, as well as good water vapour permeability.

The coating can be applied using any conventional means, including gravure, spray or print coating. The coating can have any of the features discussed above.

The coated article may be single- or double-side coated. In other words, a planar article such as a film may be coated on one or both sides.

The coated article can be any article, for example a film such as a cellulose-based film.

The coated article may be a histology quality control device, such as a reference slide. As discussed above, the coating composition of the present invention can be stained using conventional histology stains. Thus, the coating composition can be used to create a quality control device for histology staining procedures, which allows the staining of different tissue samples to be standardised.

Specifically, the quality control device can be stained along with a tissue sample. As the staining characteristics of the cellulose coating are known, the variations in staining in the tissue due to minor changes in timing, component concentration, camera used or light intensity can be identified and standardized based on the staining seen in the cellulose coating. Thus, the quality control device can be used to correct image variation in a histopathological staining and imaging process.

The quality control device of the present invention is an improvement over the devices of the prior art, which use a cellulose film that is liable to change dimensions with different hydration states. No change in size is seen in the cellulose coating of the present invention and no additional adhesion means is required to connect it to a surface, such as a slide, to create the quality control device.

The coating may not cover the entire surface of the quality control device. A tissue sample can then be positioned on the surface of the quality control device and stained simultaneously with the coating, thereby ensuring that the tissue sample and the coating are subjected to identical staining conditions. This is an improvement over the arrangements of the prior art, as the coating of the present invention is thinner than the films conventionally used. This allows a cover slip to be positioned over the tissue sample and the coating, which is not possible when using a cellulose film as the film is thicker than the tissue sample and so holds the cover slip away from the tissue sample.

The coated article may comprise further layers, such as an adhesive layer or a barrier coating. A barrier coating may comprise ethylene acrylic acid, polyvinylidene chloride, acrylic or any other barrier coating material.

According to a fourth aspect of the present invention, there is provided a method of forming a coating composition comprising the steps of homogenising a dispersion of regenerated cellulose in water. The method of the fourth aspect of the invention may have any of the features of earlier aspects.

Thus, the homogenisation may be high-pressure homogenisation. The regenerated cellulose may be regenerated from an aqueous alkali cellulose solution, preferably regenerated in a liquid phase. The regenerated cellulose may then be washed to remove the salts created by the acid.

The method of forming a coating composition may comprise the steps of:
(a) dissolving a cellulose-containing material in an alkali to form an aqueous alkali cellulose solution;
(b) regenerating the cellulose in a liquid phase by combining the aqueous alkali cellulose solution with an excess of acid under agitation;
(c) washing the resulting regenerated cellulose to achieve a cellulose dispersion in water that is substantially free of the salts created by the acid; and
(d) homogenising the cellulose dispersion in water to create a coating composition.

Any of the aspects disclosed herein can include the features of any of the earlier aspects.

The invention is further discussed in the examples and figures outlined below, which are not intended to be limiting to the scope of protection.

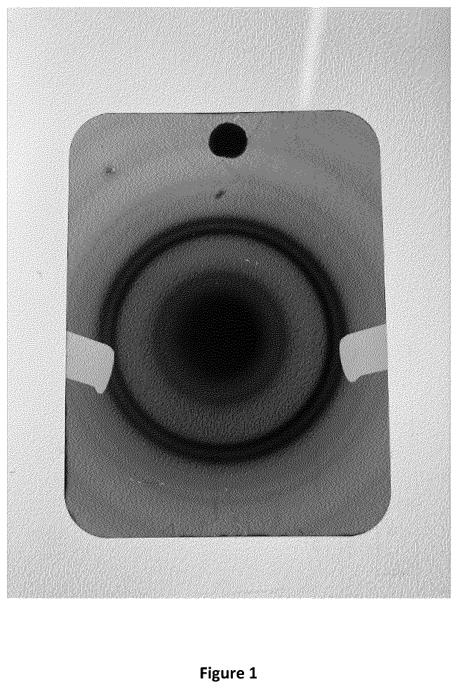

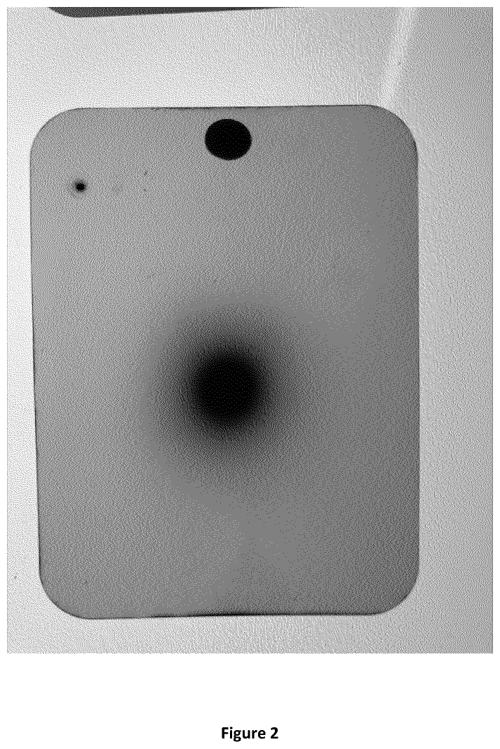

FIG. 1 illustrates an X-ray diffraction (XRD) image of a coating material according to the present invention that has been dried at over 100° C.; and FIG. 2 illustrates an XRD image of an only slightly dried coating composition according to the present invention.

### Example 1

A wood pulp was dissolved in sodium hydroxide using high-pressure homogenisation to form an aqueous sodium hydroxide cellulose solution. This solution was then added to an excess of hydrochloric acid under constant agitation. This allowed the cellulose to be regenerated in the liquid phase, creating a dispersion of regenerated cellulose in acid.

The regenerated cellulose was filtered and washed with water, before being resuspended in water to create an aqueous dispersion that was free from the salts created by the acid. The aqueous dispersion was then subjected to high-pressure homogenisation to form a coating composition.

The coating composition was coated onto a regenerated cellulose film (Natureflex™ NP), either coating one or both sides of the film with the coat weight shown in Table 1 below.

TABLE 1

| | Coat weight (gsm) |
|---|---|
| Single sided | 2.14 |
| Double sided | 3.34/2 = 1.67 per side |

The coating was dried at a temperature of above 60° C. The water vapour permeability and the wide angle haze were then measured. Wide angle haze was measured at 2.5° and in accordance with ASTM D1003.

To measure WVP, a sufficient amount of silica gel was placed in a cup so that the bottom was covered to a depth of approximately 0.8 cm. A circular sample of film, with a diameter of approximately 10 cm, was then cut. A thin layer of paraffin wax wiped onto the surface of the cup. The circular sample was placed so that its edges were in contact with the surface and pressed down, ensuring that there were no creases. The coated surface of the film was positioned towards the outside of the cup. The cup was then placed in an oven at the desired temperature and relative humidity (RH). After 24 hours, the cup was removed and weighed immediately. The cup was replaced in the oven and weighed every 24 hours until a constant gain was obtained (usually after 72 hours). The results are shown in Tables 2 and 3 below.

TABLE 2

| | Temperate Water Vapour Permeability |
|---|---|
| | (g/m2/24 hrs) |
| Single sided | 1116.25 |
| Double sided | 1053.04 |

TABLE 3

| | Wide Angle Haze (%) |
|---|---|
| Single sided | 63.4 |
| Double sided | 86.6 |

### Example 2

A solution according to the present invention was prepared, having a solids content of 2%. Two glass plates measuring 11.5 cm in length and 7.5 cm in width were placed on a drawdown bed and a coating of the solution was applied to each of the plates using a standard red K Bar (12 μm wet film deposit) at a coat weight of 6.75 g/m2. The glass plates were then removed from the drawdown bed and dried in an oven at 60° C. for 45 minutes. After the coating had completely dried, the plates were taken from the oven and left to cool to room temperature, which took around 5 minutes.

One glass plate was placed onto a solid, flat surface and the coating was scratched along its entire length in a continuous motion with a penny. No visible removal of the coating was identified.

The other glass plate was placed onto a solid, flat surface and a strip of scotch tape 600 was firmly adhered to the full width of the coated plate, with the ends of the tape extending beyond the width of the plate. One end of the tape was then held at a 180° angle and removed quickly. The area over which the coating was removed was then calculated and compared to the total area over which the tape was adhered to the coated plate. Less than 5% of the coating by area had been removed, thereby demonstrating that the coating demonstrated good adhesion.

### Example 3

A solution according to the present invention was prepared, having a solids content of 2%. Two glass plates measuring 11.5 cm in length and 7.5 cm in width were placed on a drawdown bed and a coating of the solution was applied to each plate using a standard red K Bar (12 μm wet film deposit) at a coat weight of 6.75 g/m2. The glass plates were then removed from the drawdown bed and dried at room temperature for 24 hours.

One glass plate was placed onto a solid, flat surface and the coating was scratched along its entire length in a continuous motion with a penny. A portion of the coating was removed to reveal the glass underneath. This demonstrates that the coating of the invention when dried at room temperature is much softer, with a lower adhesion, compared to when dried at elevated temperatures.

The other glass plate was placed onto a solid, flat surface and a strip of scotch tape 600 was firmly adhered to the full width of the coated plate, with the ends of the tape extending beyond the width of the plate. One end of the tape was then held at a 180° angle and removed quickly. The area over which the coating was removed was then calculated and compared to the total area over which the tape was adhered to the coated plate. More than 5% of the coating by area had been removed, thereby demonstrating that the coating demonstrated less good adhesion than the coating dried at elevated temperatures.

### Example 4

FIG. 1 illustrates an X-ray diffraction (XRD) image of a coating material according to the present invention that has been dried at over 100° C. In XRD, cellulose I is characterized by the two peaks in the middle of the scan and a wide peak further along the scan, while cellulose II is characterized by the one peak near the central beam at the beginning of the scan and two peaks further along the scan.

FIG. 1 shows that the coating of the present invention is almost entirely cellulose II. From a line scan of FIG. 1, it was found that the coating material had a crystallinity of around 80%.

In contrast, FIG. 2 illustrates an XRD image of an only slightly dried coating composition according to the present invention. This shows that the coating composition has almost no diffraction, suggesting a very low level of crystallinity.

FIGS. 1 and 2 therefore illustrate that the coating composition according to the invention is predominantly amorphous before it has been dried, but is then predominantly crystalline cellulose II after drying at a temperature above room temperature.

1. A coating composition comprising a homogenised dispersion of regenerated cellulose in water, wherein the regenerated cellulose comprises both amorphous and crystalline cellulose.

2. The coating composition of claim 1, wherein the regenerated cellulose has been regenerated in a liquid phase from an aqueous alkali cellulose solution.

3. The coating composition of claim 2, wherein the homogenised dispersion of regenerated cellulose in water is obtained using a method comprising the steps of:
(a) dissolving a cellulose-containing material in an aqueous alkali to form an aqueous alkali cellulose solution;
(b) regenerating the cellulose in a liquid phase by combining the aqueous alkali cellulose solution with an excess of acid under agitation;
(c) washing the resulting regenerated cellulose to achieve a cellulose dispersion in water that is substantially free of the salts created by the acid; and
(d) homogenising the cellulose dispersion in water.

4. The method of claim 24, wherein the aqueous alkali in step (a) is a hydroxide.

5. The coating composition method according to claim 24, wherein step (a) comprises homogenisation to aid dissolution.

6. The method of claim 24, wherein step (b) comprises adding the aqueous alkali cellulose solution to the acid, or adding the acid to the aqueous alkali cellulose solution.

7. The method of claim 24, wherein step (c) comprises separating the regenerated cellulose from the acid, washing and resuspending in water to form a dispersion in water, or wherein step (c) comprises continuous washing to remove the acid and create a cellulose dispersion in water.

8. The coating composition claim 1, wherein the homogenised dispersion of regenerated cellulose in water has undergone high-pressure homogenisation.

9. The coating composition of claim 1, wherein the homogenised dispersion of regenerated cellulose in water comprises between 1 and 10% w/w cellulose.

10. The coating composition of claim 2, wherein the aqueous alkali cellulose solution is produced using the steps of:
(a) neutralising an alkaline cellulose-containing precursor material with an acid and obtaining a neutralised solid cellulose-containing material;
(b) mixing the neutralised solid cellulose-containing material with bleach to create a mixture;
(c) separating a solid purified cellulose-containing product from the mixture; and
(d) dissolving the solid purified cellulose-containing product in an aqueous alkali.

11. The coating composition of claim 1, further comprising one or more additives selected from a wax, a bio-polymer, a pigment, an active ingredient, a reference particle or a dopant for stain uptake.

12. The coating composition of claim 1, comprising cellulose particles having an average radius of less than 1 micron.

13. A coating comprising the cellulose coating composition of claim 1.

14. The coating of claim 13, wherein the coating has a thickness of between 0.1 and 50 microns.

15. The coating of claim 13, having a coat weight of between 0.1 and 20 gsm.

16. The coating of claim 13, having a wide angle haze of between 50 and 75%.

17. The coating of claim 13, having a water vapour permeability of between 1000 and 1250 g/m²/24 hours.

18. The coating of claim 13, wherein the coating comprises less than 50% w/w of the cellulose coating composition.

19. The coating of claim 13, wherein the coating has been dried at above 25° C.

20. The coating of claim 19, having a crystallinity of above 60%.

21. A coated article, comprising the coating of claim 13.

22. The coated article of claim 21, wherein the coating has been applied by gravure, spray or print coating.

23. The coated article of claim 21, wherein the article is a film or a histology quality control device.

24. A method of forming a coating composition comprising the steps of:
(a) dissolving a cellulose-containing material in an aqueous alkali to form an aqueous alkali cellulose solution;
(b) regenerating the cellulose in a liquid phase by combining the aqueous alkali cellulose solution with an excess of acid under agitation;
(c) washing the resulting regenerated cellulose to achieve a cellulose dispersion in water that is substantially free of the salts created by the acid; and
(d) homogenising the cellulose dispersion in water to create a coating composition.
